(19) United States
(12) Patent Application Publication
(10) Pub. No.: US 2026/0220571 A1
(43) Pub. Date: Jul. 30, 2026

(54) METHOD FOR DRIVING INSTRUCTION FOR RIDE-SHARING SOLUTION

(71) Applicant: Jarvis Earl Gandy, San Diego, CA (US)

(72) Inventor: Jarvis Earl Gandy, San Diego, CA (US)

(21) Appl. No.: 19/463,698

(22) Filed: Jan. 29, 2026

Related U.S. Application Data
(60) Provisional application No. 63/751,728, filed on Jan. 30, 2025.

(51) Int. Cl. G06Q 10/0631; G06Q 50/47; G09B 19/16

(52) U.S. Cl. CPC G06Q 10/06312; G06Q 50/47; G09B 19/167

(57) ABSTRACT

A method used by a student to schedule a driving class or a request to use a car for taking a DMV driving exam and match the student to a certified driving instructor or a driver, in which lesson is planned based on data collected from the student or a trip is planned based on when the student plans to take the DMV driving exam.

### CROSS-REFERENCE TO RELATED APPLICATIONS

This application claims benefit of priority to U.S. Provisional Application No. 63/751,728, filed on January 30, 2025, entitled “METHOD FOR DRIVING INSTRUCTION FOR RIDE-SHARING SOLUTION,” the entire disclosure of which is incorporated by reference herein.

### FIELD OF THE DISCLOSURE

This application relates to driving education methods.

### BACKGROUND

Driving education is an essential skill in today’s society. With the growing population, access to appropriate and qualified instructors is of extremely importance. Driving instructors play an increasingly important role in today’s world. Roads are busier, vehicles are faster, and distractions (especially smartphones) are common. Professional instructors teach not just how to operate a vehicle, but how to anticipate hazards, manage risks, and drive defensively. Learning from family or friends can be stressful or inconsistent. Instructors provide structured, calm, and experienced guidance that helps learners become confident and capable behind the wheel.

Driving instructors teach up to date rules, such as traffic laws, vehicle technology, and road layouts, since they stay trained on new updates. Instructors model patience, discipline, and respect for other road users. This influences new drivers’ long-term habits, promoting safer and more courteous road behavior.

Driving instructors prepare learners to pass the driving exam at the DMV. Instructors understand the testing standards and help learners develop the exact skills needed to pass safely and confidently.

Today’s methods to find an in-person driving instructor in which the student can use/drive the car during the DMV driving exam can be modernized. There is a need for a more update method to match leaners with instructors according to the need of the students and particular skills possessed by driving instructors.

### SUMMARY OF THE INVENTION

The present invention overcomes disadvantages of the prior art by providing a method that qualifies the need of a learner and matches those needs with driving instructors that excel on those needs of the learner. Additionally, the invention allows the Requester/Leaner to choose male or female instructor.

In a preferred embodiment of the invention, there is a requester/student/user who requests a ride. The user specifies a pick-up location and a destination. The method also consists of a tracking system to keep and collect data of the ride and position of the car/ride until the ride is over. The request gets picked up or assigned to a driver who will provide a driving lesson or allow the user to use the car during the DMV driving exam based on a previous taken online test and questionnaire by the user/student/requester. Additionally, after the DMV exam, the car/ride can be finalized once the student/requester returns home or an additional destination.

In certain cases, the destination of the ride will be a DMV (Department of Motor Vehicles) location. In which the student will be taking the driving exam.

In certain embodiments, the database of available drivers consists of only certified trained driving teachers.

In certain embodiments, the database of available drivers consists of non-certified driving teachers.

In certain embodiments, the requester is not the student, but a parent or guardian requesting a ride for the student.

In certain embodiments, the lesson involves DMV Logic, which consist of processes applied at a DMV office to facilitate test taking and processing forms in order for the student to be ready and prepared for his/her driving exam.

In other embodiments, the invention can predict future ride requests based on data collected from the user and suggest ahead of time the request. This can be used as a reminder for the learner to avoid forgetting placing a request. Additionally, if permission is granted, the invention can schedule ahead based on prediction data without requesting permission from the user every time.

In other embodiments, the invention is also able to provide personalized surge-pricing.

In other embodiments, the invention has the capability to continually check for identity of the Requester and Driver for verification purposes and to prevent unauthorized driver substitutions or unauthorized account sharing.

In other embodiments, the invention/method uses data collected to provide the best route to take based on the skills the learner wants to practice.

In other embodiments, the invention/method can adapt the ride based on the needs of the leaner and other collected data.

In other embodiments, the invention/method can be scheduled as an exclusive ride or share ride.

In other embodiments, the invention/method can be scheduled as a silent mode ride.

In an embodiment of the invention, the method assesses the areas in which the learner/student has a deficiency by having the student take a preliminary assessment test. The results get quantified and assigned to specific sections of the driving learning experience.

The results get compared to the repository of driving instructors in the system. Based on the results, a list of recommended instructors gets produced for the student/learner.

In other embodiments, the student can specify certain areas they want to practice, then a list of recommended instructors get populated for the student.

In other embodiments, both, the results from a preliminary test and the individual needs inputted by the learner/students can be used to further narrow the specific needs of the learner/student. Such data gets compared against the database of qualified instructors. Then a list of recommended instructors is populated for the student/learner.

In certain embodiments, the instructor drives the student to the exam, and waits for the student finish the exam, then drives the student back to the house or an additional destination.

In certain embodiments, driving schools can sign up for the program database to be part of the repository of instructors.

In certain embodiments, instructors need to have appropriate state qualifications (such as a second brake on the car).

The foregoing and other features and advantages of the invention will be apparent from the following, more particular description of the invention’s preferred embodiments, the accompanying drawing, and the claims.

### BRIEF DESCRIPTION OF THE DRAWINGS

For a more complete understanding of the present invention and advantages thereof, reference is now made to the ensuing descriptions taken in connection with the accompanying drawings briefly described as follows.

FIG. 1 shows an overview of the method from start to finish on how a user/student gets matched with a driver.

FIG. 2 shows an overview of the method showing the steps on how a user/student can request to drive the driver’s car to practice his/her driving.

FIG. 3 shows an overview of the method showing the steps on how a user/student can borrow/use a driver’s car during the actual driving exam at the DMV.

FIG. 4 shows an overview of the method showing the steps on how a driving lesson gets created and a user/student gets access to a list of recommended drivers/instructors.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF THE DRAWINGS

The following detailed description is merely exemplary in nature and does not limit this disclosure or the application and uses of the invention. As used here, the word “exemplary” means “serving as an example, instance, or illustration.” Thus, any embodiment described here as “exemplary” is not necessarily to be construed as preferred or advantageous over other embodiments. Furthermore, there is no intention to be bound by any expressed or implied theory presented in the preceding technical field, background, brief summary, or the following detailed description.

Described here is a method that allows a student to learn, drive, take lessons, and take rides from a driving instructor to the DMV.

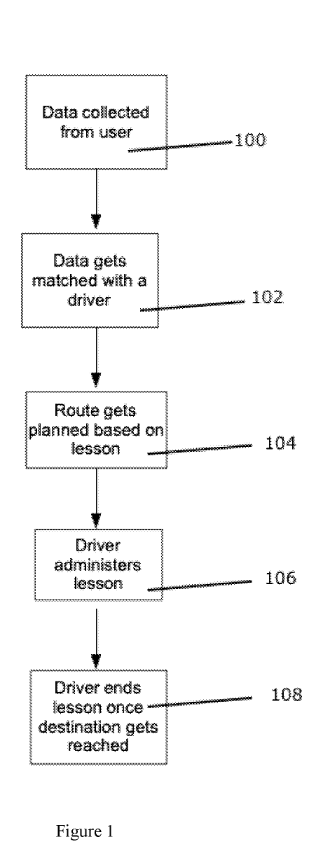

Preferred embodiments of the present invention and their advantages may be understood by referring to FIG. 1 wherein like reference numerals refer to like elements

FIG. 1 is a high-level drawing depicting the steps and main process of the preferred embodiment of the method. The method consists of the system collecting data 100 from a user. The data then gets analyzed and matched 102 with a driving instructor. Based on the driver chosen and the data collected from the user, a route and lesson 104 gets planned. Then the driver administers the lesson 106 following the planner route by the method/invention. The lesson ends 108 on the ride reaches the final destination established by the user/student.

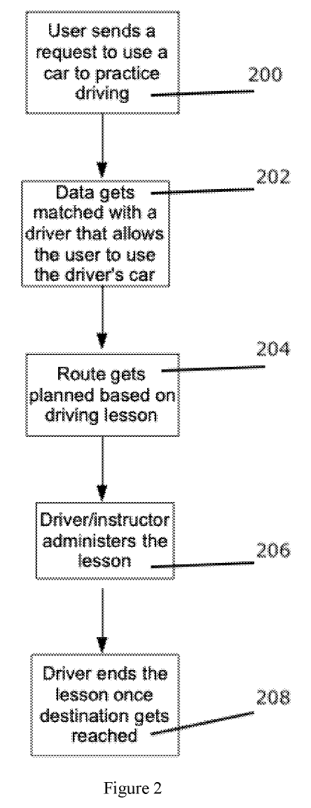

FIG. 2 is a drawing depicting the steps for a user/requester/student requests to use a car to practice driving. The user sends request 200 to use a car to practice driving. The data gets matched 202 with a driver that allows the user/requester to use the driver’s car. Based on data collected, route gets planned 204 for the requester/user/student to use the car to practice hi/her driving during that route. The driver instructor administers the lesson 206. The lesson ends once the destination of the route is reached 208. In certain cases, the destination can be the start point and in other cases, the destination could be any destination the user/student/requester needs to get to.

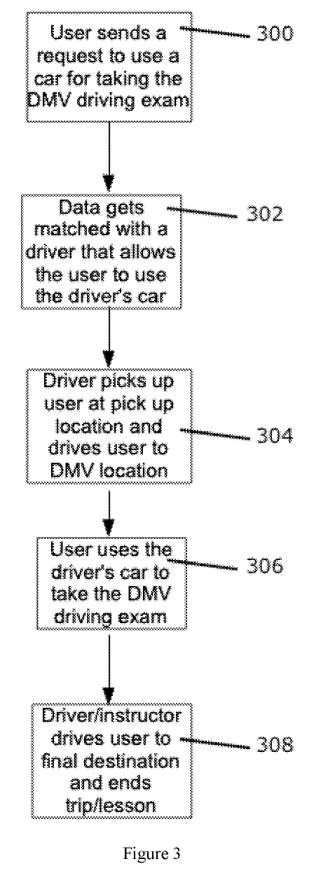

FIG. 3 is a drawing depicting the steps for a user to request to use a car during the actual DMV driving exam. The user sends a request 300 to use a car during the DMV driving exam. The request gets matched with a driver 302 or a list of drivers gets suggested for the use to choose from. The chosen driver picks up the user from pick up location 304 and drives the user to the DMV location. At the DMV location, the user is allowed to use the driver’s car to take the actual DMV driving exam. After the exam, the driver drives the user to the final destination and ends the trip.

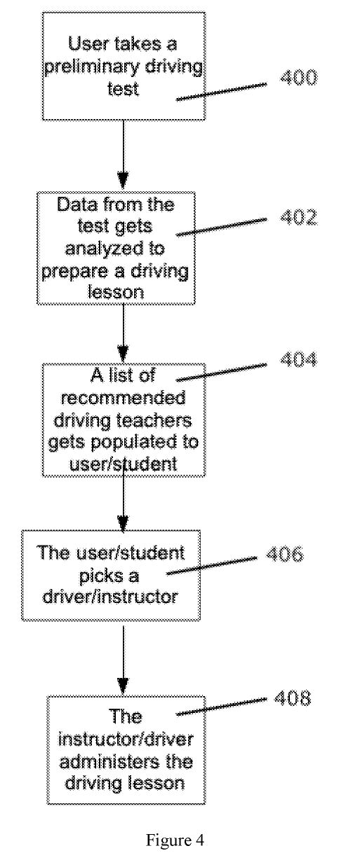

FIG. 4 is a drawing depicting how a student can take a preliminary test to make the driving lesson more specific. The user takes a preliminary online test 400. Data from the test gets analyzed and a driving lesson gets prepared 402. The list of recommended instructors/drivers gets populated to the student/user/requester 404. The student/user/requester picks an instructor/driver 406. The instructor/driver administers the driving lesson 408.

What is claimed is:

1. A method for ride-sharing comprising:
a request for a ride;
a requester sharing pick-up location;
a requester sharing a destination location;
a tracking system;
a database of available drivers;
wherein a driver from the database is matched with requester;
a driving lesson administered by the driver
wherein the driving lesson is prepared by the requester taking an online test and answering a questionnaire
an available vehicle that the requester is able to drive to the DMV to the take a DMV driving exam,
wherein the vehicle belongs driver.

2. The method of claim 1, wherein the destination location is a Department of Motor Vehicle location.

3. The method of claim 1, wherein the database of available drivers consists of certified trained driving teachers.

4. The method of claim 1, wherein the requester is not the person being driven to the destination.

5. The method of claim 1, wherein the driving lesson involves DMV Logic.
